(19) United States
(12) Patent Application Publication
(10) Pub. No.: US 2013/0323111 A1
(43) Pub. Date: Dec. 5, 2013

(54) METHOD OF PRODUCTION OF RARE EARTH MAGNET

(71) Applicants: Noritaka Miyamoto, Toyota-shi (JP); Tetsuya Shoji, Toyota-shi (JP); Shinya Omura, Nagoya-shi (JP); Daisuke Ichigozaki, Toyota-shi (JP); Akira Manabe, Miyoshi-shi (JP)

(72) Inventors: Noritaka Miyamoto, Toyota-shi (JP); Tetsuya Shoji, Toyota-shi (JP); Shinya Omura, Nagoya-shi (JP); Daisuke Ichigozaki, Toyota-shi (JP); Akira Manabe, Miyoshi-shi (JP)

(73) Assignee: TOYOTA JIDOSHA KABUSHIKI KAISHA, Toyota-shi, Aichi (JP)

(21) Appl. No.: 13/982,533

(22) PCT Filed: Feb. 21, 2011
(86) PCT No.: PCT/JP2011/054410

§ 371 Date: Jul. 30, 2013

(51) Int. Cl. H01F 41/02

(52) U.S. Cl. CPC H01F 41/0246
USPC 419/65

(57) ABSTRACT

The present invention provides a method of production of a rare earth magnet which achieves high magnetization by hot working and at the same time secures high coercivity.

A method of production of the present invention is a method for producing an R-T-B-based rare earth magnet comprising: molding a powder of an R-T-B-based rare earth alloy (R: rare earth element, T: Fe or Fe part of which is substituted by Co) to form a bulk; then hot working the bulk; and before the molding, mixing with the powder of an R-T-B-based rare earth alloy either a metal which forms a liquid phase in copresence with R at a temperature lower than the hot working temperature, or an alloy which forms a liquid phase at a temperature lower than the hot working temperature.

### TECHNICAL FIELD

The present invention relates to a method of using hot working to produce a rare earth magnet.

### BACKGROUND ART

Rare earth magnets such as neodymium magnets (Nd₂Fe₁₄B) are being used for various applications as extremely powerful permanent magnets with a high flux density.

It is known that neodymium magnets become higher in coercivity the smaller the crystal grain size. Therefore, the practice has been to fill magnetic powder of nano polycrystals of a crystal grain size of about 50 to 100 nm (powder particle size of about 100 μm) in a die and hot press it so as to form a bulk while maintaining the nano polycrystalline state. However, with just this, the individual nano crystal grains become diverse in orientation and therefore a large magnetization cannot be obtained. Therefore, to orient the crystals, it is known to perform hot working so as to align the crystal grains in orientation by crystal slipping and thereby obtain a magnet which has a high magnetization of 1T or more.

However, if performing hot working for orienting the crystals, the orientation causes the magnetization to become greater, but there was the problem that the coercivity ended up falling.

As a countermeasure, for example, Chemical Industry Daily (Aug. 31, 2010 edition) proposed mixing NdCu alloy powder with neodymium magnet powder which is prepared by the HDDR (hydrogenation, disproportionation, desorption, recombination) method and heat treating the mixture so as to magnetically split the grain boundaries so as to raise the coercivity. However, even if using the HDDR method or the rapid solidification method to try to make an NdCu alloy or other reforming components disperse at the grain boundaries of a nanocrystal magnet, the smaller the crystal grains, the greater the surface area of the crystal grains, so causing sufficient permeation is difficult with just heat treatment. To cause sufficient permeation of the reforming components, high temperature, long heat treatment is required, the crystal grains end up growing, and the coercivity drops. Not only this, when using a Dy-based reforming element, volume diffusion proceeds, so the magnetization remarkably falls.

Japanese Patent Publication No. 2010-114200A proposes to heat treat an alloy containing Dy or Tb in a state in contact with the nanocrystal magnet so as to reform the grain boundaries. However, with this method, the coercivity is improved at the surface of the bulk magnet, but the effect does not reach the inside of the magnet. Further, in this case as well, due to use of Dy, the magnetization falls near the surface part.

Japanese Patent Publication No. 2010-103346A discloses a method of production of a magnet comprising molding a mixed powder of an Nd—Fe—B or other alloy powder and DyF₃, Ca, etc. alone or as a hydrogenate to form a bulk and then hot working the bulk. It is possible for solid state DyF₃ to easily diffuse for enrichment in the crystal grain boundary phase which has been partially converted to a liquid phase, so due to the magnetic splitting effect of DyF₃, the coercivity can be raised. However, since the solid component diffuses, the DyF₃ did not diffuse to the slip planes at the time of hot working and there was a limit to improvement of the coercivity.

### SUMMARY OF INVENTION

The present invention has as its object to provision of a method of production of a rare earth magnet which achieves high magnetization by hot working and simultaneously secures high coercivity.

The above object is achieved according to the present invention by a method for producing an R-T-B-based rare earth magnet comprising:

molding a powder of an R-T-B-based rare earth alloy (R: rare earth element, T: Fe or Fe part of which is substituted by Co) into a bulk;

then hot working the bulk, and

before the molding, mixing with the powder of an R-T-B-based rare earth alloy either a metal which forms a liquid phase in copresence with R at a temperature lower than the hot working temperature, or an alloy which forms a liquid phase at a temperature lower than the hot working temperature.

According to the present invention, a metal which forms a liquid phase in copresence with R at a temperature lower than the hot working temperature or an alloy which forms a liquid phase at a temperature lower than the hot working temperature is mixed with a powder of an R-T-B-based rare earth alloy, then the mixture is molded into a bulk and then the bulk is hot worked. The mixed metal together with the rare earth metal R, or the mixed alloy itself, forms a liquid phase during hot working (that is, part or all melts). This liquid phase permeates to the crystal grain boundaries of the polycrystalline rare earth alloy powder. Not only that, it also permeates to the slip planes in the crystal grains generated by the hot working.

In the state of the lowered temperature after completion of the hot working, the solidified phase from the liquid phase (alloy or mixture of mixed metal and rare earth metal R or mixed alloy itself) is present in a state coating not only the crystal grain boundaries of the rare earth alloy but also the slip planes inside the crystal grains. Therefore, not only is the effect of magnetic splitting in units of crystal grains exhibited as in the conventional art, but also, as a characteristic of the present invention, the effect of magnetic splitting is also exhibited in units of slip regions in the crystal grains (size of fraction of crystal grains), so that a high coercivity which could not be obtained in the conventional art is secured while the high magnetization of the inherent effect of hot working is achieved.

Below, to simplify the explanation, the “mixed metal” will sometimes be referred to as the “added metal”, the “mixed alloy” will sometimes be referred to as the “added alloy”, and the two will sometimes be referred to together as the “added components”.

### BRIEF DESCRIPTION OF DRAWINGS

FIG. 1 schematically shows the apparatus for molding (forming the bulk) and hot working of the present invention and the operation of the same.

FIG. 2 schematically shows the change in the crystal grain structure of a rare earth alloy due to hot working of the present invention.

FIG. 3 shows the changes in the coercivity and residual flux density with respect to the amount of Nd in a Nd₂Fe₁₄B rare earth alloy.

FIG. 4 shows the effect of the average particle size of the added alloy NdCu on the coercivity.

FIG. 5 shows the effect of the hot working temperature for the case of the added alloy NdMn.

FIG. 6 shows the effects of the amounts of addition for the added components NdCu and NdAl.

FIG. 7 schematically shows a sputtering apparatus for coating a rare earth alloy powder with added components.

### EMBODIMENTS FOR CARRYING OUT INVENTION

The method of the present invention is characterized by adding and mixing a low melting point metal or alloy which forms a liquid phase at the hot working temperature at the time of crystal slipping due to hot working to a powder of NdFeB or other rare earth magnet alloy, molding the mixture (forming a bulk), then hot working the bulk. However, the added metal, even if not itself a low melting point one, need only form a liquid phase in the state where part or all is alloyed with the rare earth element (Nd etc.) of the rare earth magnet alloy at the hot working temperature.

For example, a low melting point alloy comprised of NdCu, NdAl, etc. is mixed with a rare earth magnet alloy comprised of a Nd₂Fe₁₄B nanocrystal magnetic powder which has a Nd-rich phase fraction. The mixed powder is molded to form a bluk, then the bulk is hot worked.

The metal or alloy is added to the rare earth magnet alloy powder by (1) mixing the metal or alloy as a powder to the rare earth magnet alloy powder or (2) sputtering the metal or alloy on the surface of particles of the rare earth magnet alloy powder.

<Basic Process>

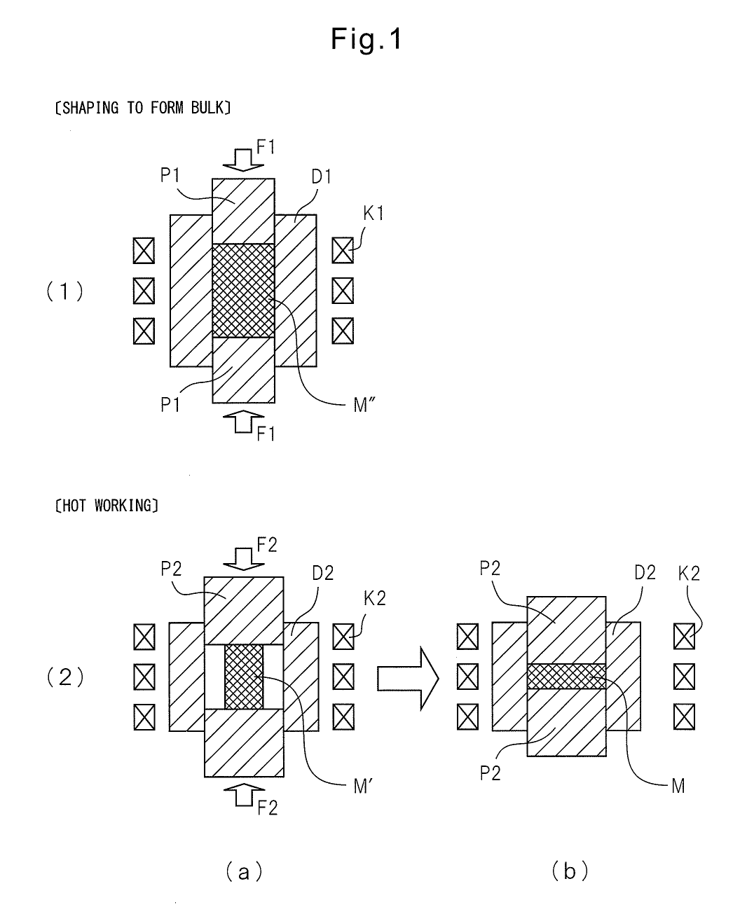

This will be explained while referring to FIG. 1.

[Molding (Formation of Bulk)>

First, the mixed powder M″ is molded by the hot press etc. which is shown in FIG. 1(1) to form a bulk. That is, the die D1 of the hot press is filled with the mixed powder M″, then the mixed powder M″ is compression molded by heating by a heating coil K1 while applying a force F1 by punches P1 from the top and bottom.

The force F1 for forming the mixed powder M″ into a bulk is of a magnitude required for making the powder particles of the polycrystals bond with each other, but the deformation of the individual crystal grains themselves forming the powder particles is of a negligible extent.

The powder is molded for formation of a bulk by hot pressing etc. in a reduced pressure atmosphere or Ar atmosphere or other nonoxidizing atmosphere at a temperature of less than 750° C. If the molding temperature becomes 750° C. or more, grain growth easily occurs and becomes a cause of a drop in the coercivity. Furthermore, the bulk with the coarsened crystal grains becomes harder to orient (becomes anisotropic) by rotation of the crystal grains in the later hot working.

[Hot Working]

The bulk M′ which is obtained by the molding is hot worked by a hot forge etc. shown in FIG. 1(2)(a). In this case, in the hot forge, the bulk M′ is loaded into a die D2 of a size not constraining its periphery and is heated by a heating coil K2 while applying a force F2 from the top and bottom by punches P2 for hot working. That is, the bulk is swaged by a working degree of 60 to 80% or a working degree larger than that to obtain a rare earth magnet M of a final shape such as shown in FIG. 1(b).

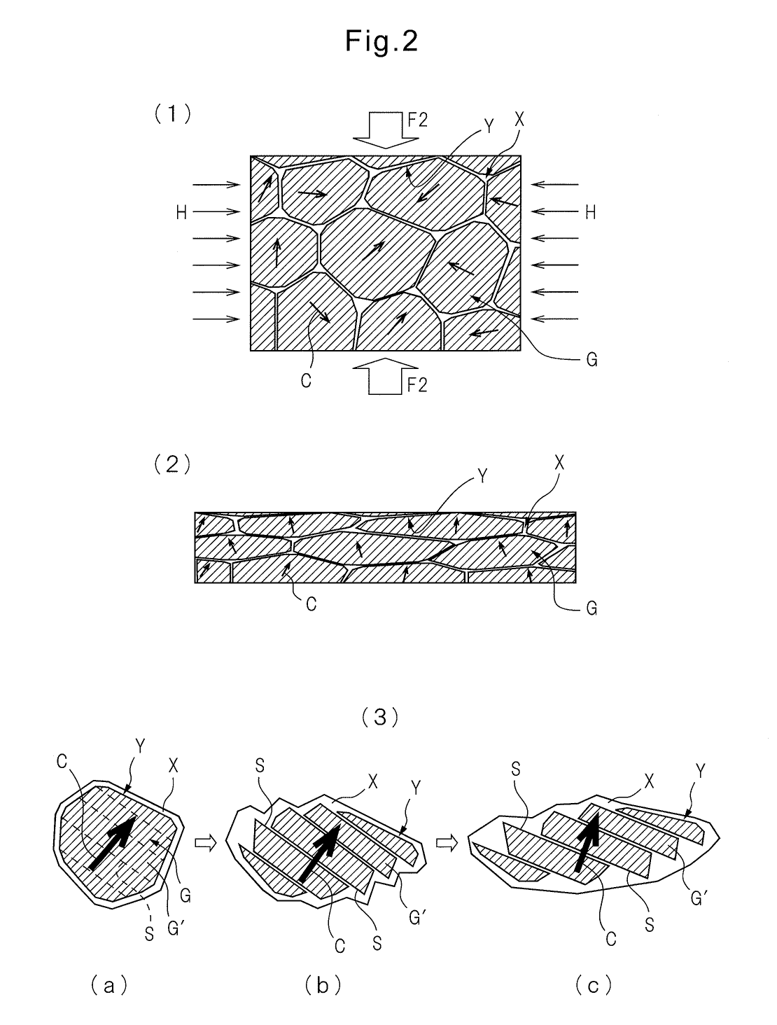

FIG. 2 shows (1) the crystal grain structure before hot working, (2) the crystal structure during (or after) hot working, and (3) the slip deformation of the crystal grains and permeation of the liquid phase during hot working. Heating H was used to hold the hot working temperature and force F2 was applied from the top and bottom for swaging. At the crystal grain boundaries Y around the crystal grains G, the alloy of the added metal and the rare earth metal or the added alloy is present as the liquid phase X.

In this hot working, a liquid phase X of the alloy of the added metal and the rare earth metal or the added alloy is formed. It permeates to the crystal grain boundaries Y of the polycrystal and the slip planes S inside the individual crystal grains and promotes the orientation of the C axis (axis of easy magnetization) by rotation and deformation of the crystals G (orientation along swaging direction) to achieve high magnetization (FIG. 2(3)(a)→(c)) while simultaneously exhibiting the effect of magnetic splitting not only at the crystal grain boundaries Y, but also at the slip planes in the individual crystal grains to secure a high coercivity. In particular, as shown in FIG. 2(3), a single crystal grain G is split into a plurality of slip regions G′ by the slip planes S along with the progress in the hot working. The liquid phase X permeating to the slip planes S between the slip regions G′ is magnetically split between the slip regions G′. That is, it is possible to realize not only magnetic splitting between crystal grains, but also magnetic splitting between the slip regions inside the individual crystal grains. In the past, even if improving the orientation to obtain a large magnetization by hot working, a high coercivity could not be obtained, but according to the present invention, it becomes possible to obtain a large magnetization while securing a high coercivity.

The hot working is performed under reduced pressure or in an Ar or other inert atmosphere at preferably 600° C. to 800° C. The strain velocity does not have to be particularly limited, but is 0.1/sec or more, preferably 1/sec or more.

If less than 600° C., cracks easily form in the bulk.

On the other hand, if over 800° C., the softening of the grain boundary phase which is rich in the rare earth element R becomes remarkable, deformation of the grain boundaries and deformation due to rotation of the crystal grains end up occurring with priority, slip deformation ends up becoming difficult to occur, and the effect of magnetic splitting by permeation of the liquid phase in the slip plane becomes hard to occur. Furthermore, grain growth also becomes remarkable, orientation does not proceed, and no improvement in magnetization is obtained.

[Heat Treatment: Optional]

After the completion of hot working, working strain remains, so sometimes variation occurs due to the drop in coercivity. In such a case, to stabilize the quality, it is possible to perform heat treatment for relieving the strain. The heat treatment temperature is made a range of the temperature at which the low melting point phases of the crystal grain boundaries and slip planes (mainly solidified phases of liquid phases of added components) remelt to the temperature at which coarsening of the crystal grains occurs. By making the low melting point phase remelt at the crystal grain boundaries and slip planes remelt, the strain is relieved and the effect of magnetic splitting is also improved, so a stable high coercivity is obtained. A temperature of 550 to 700° C. and a time of within 3 hours are preferable.

However, according to the present invention, long term heat treatment is not necessary for permeation of the liquid phase like in the past, so the coercivity is not liable to drop due to the growth of the crystal grains.

<Material Composition>

[Rare Earth Alloy]

The composition which is covered by the present invention is an R-T-B-based rare earth magnet.

R is a rare earth element and is typically one or more of Nd, Pr, Dy, Tb, and Ho. In particular, it is Nd or Nd of which part is substituted at least one type of element of Pr, Dy, Tb, and Ho. As the rare earth element, the intermediate product of Nd and Pr, that is, Di, is also included. A heavy rare earth metal such as Dy is also included.

In the present invention, from the viewpoint of both the coercivity and magnetization (residual flux density), the content of the rare earth element R in the rare earth alloy is desirably 27 to 33 wt %.

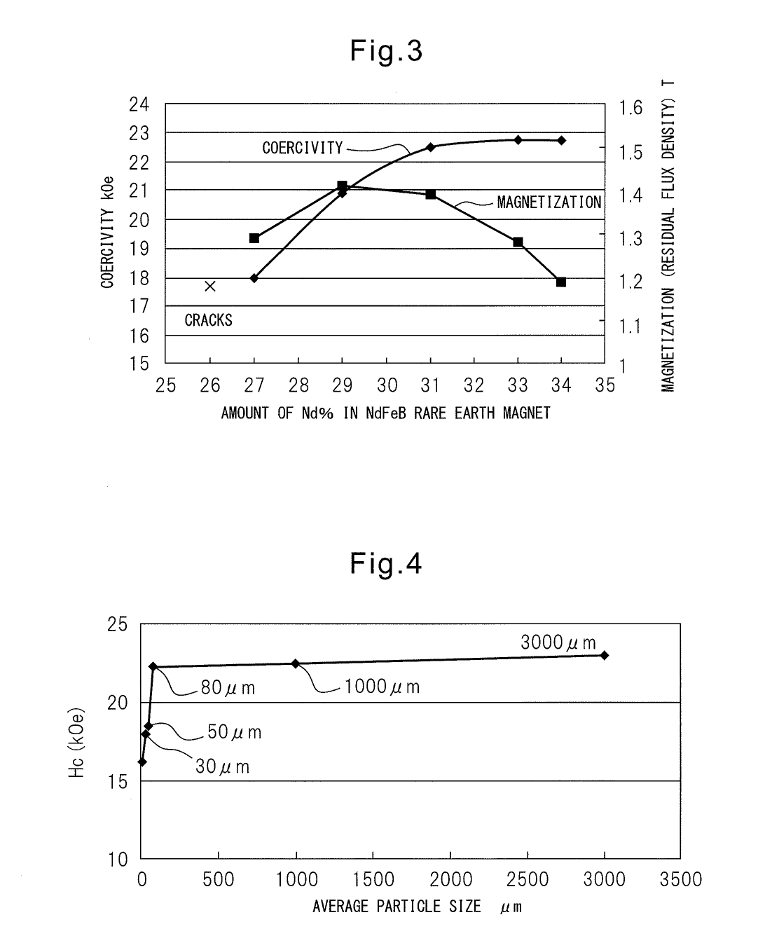

FIG. 3 shows the change of coercivity and residual flux density with respect to the amount of Nd in the Nd₂Fe₁₄B rare earth alloy as a typical example.

If the amount of Nd is less than 27 wt %, the magnetic splitting effect becomes insufficient and the base coercivity falls. Further, cracking easily occurs in hot working.

On the other hand, if the amount of Nd exceeds 33 wt %, the main phase rate falls and the magnetization becomes insufficient.

The particle size of the rare earth alloy powder of the present invention may be 2 mm or less, but is preferably 200 μm or less. The alloy is crushed in an Ar, N₂, or other inert gas atmosphere to prevent oxidation.

[Added Metal and Alloy]

The method of present invention is to add and mix the added metal (that is, a metal which forms a liquid phase in copresence with R at a temperature lower than the hot working temperature) and added alloy (that is, an alloy which forms a liquid phase at a temperature lower than the hot working temperature) to the rare earth magnet alloy powder before molding.

[Added Metal]

The added metal is a metal which forms a liquid phase in the copresence of a rare earth element R (state where part or all is alloyed) at the hot working temperature, preferably 700° C. or less. The added metal is at least one type which is selected from Cu, Al, Ni, Co, Mn, Zn, Al, Ga, In, and Mg.

When adding the added metal by a powder, to facilitate mixing with the rare earth magnet alloy powder, preferably the added metal powder is made an average particle size of 100 μm or less.

[Added Alloy]

The alloy is an alloy of a rare earth element R and the added metal and a metal which forms a liquid phase at the hot working temperature, preferably 670° C. or less. Here, the rare earth element R of the added alloy may be the same as or different from the rare earth element R of the rare earth alloy magnet. It may be a single element or a plurality of elements. The rare earth element R of the rare earth magnet alloy is selected from the range of the types of elements.

When adding an added alloy by powder, to make oxidation difficult, preferably the added alloy powder is made an average particle size of 80 μm or more. However, if the particle size becomes too large, the powder easily becomes uneven at the time of mixing, so the particle size is preferably made 1 mm or less.

[Amount of Addition of Added Metal or Added Alloy]

The amount of addition of the added metal or added alloy to the rare earth magnet alloy may be selected in a range giving the effect of permeation of the liquid phase according to the present invention and free of detrimental effects in the magnetic properties of the magnet and is preferably 0.3 to 5 wt %, more preferably 0.5 to 5 wt %. The amount of addition will be explained in detail in Example 2.

### EXAMPLES

### Example 1

The rare earth magnet materials were blended in predetermined amounts in accordance with an alloy composition (mass %): 31Nd-3Co-1B-0.4Ga-bal.Fe, the mixture was melted in an Ar atmosphere, and the melt was ejected from an orifice to a rotary roll (chrome-plated copper roll) for rapid cooling so as to produce a thin piece of alloy. This thin piece of alloy was comminuted in an Ar atmosphere by a cutter mill and sieved to obtain a rare earth alloy powder of a particle size of 2 mm or less (average particle size 100 μm). The crystal grain size of the powder particles was about 100 nm and the amount of oxygen was 800 ppm.

To the rare earth alloy powder, as shown in Table 1, metal powder of an average particle size of about 10 μm or less or alloy powder of an average particle size of 80 μm or more was added in the amount of addition which is shown in Table 1 to prepare a mixed powder.

The compositions of the added alloys were as follows:

NdCu: Nd-15 wt % Cu

NdAl: Nd-3 wt % Al

NdMn: Nd-15 wt % Mn

PrCu: Pr-18 wt % Cu

DyCu: Dy-14 wt % Cu

DyAl: Dy-4 wt % Al

DyCuAl: Dy-14 wt % Cu-4 wt % Al

TABLE 1

| | Amount | Bulk | | After hot working | |
|---|---|---|---|---|---|
| Added | of addition | | Magneti- | | Magneti- |
| component | (wt %) | Coercivity | zation | Coercivity | zation |
| None | — | 17.0 | 0.80 | 16.0 | 1.43 |
| Cu | 3 | 17.8 | 0.78 | 18.2 | 1.43 |
| Al | 3 | 17.9 | 0.77 | 18.5 | 1.40 |
| NdCu | 3 | 18.2 | 0.78 | 22.5 | 1.39 |
| NdAl | 3 | 17.2 | 0.79 | 22.7 | 1.38 |
| NdMn | 3 | 15.8 | 0.79 | 20.2 | 1.40 |
| PrCu | 3 | 18.3 | 0.77 | 22.7 | 1.36 |
| DyCu | 0.4 | 20.2 | 0.76 | 21.2 | 1.35 |
| DyAl | 0.4 | 20.4 | 0.75 | 22.2 | 1.35 |
| DyCuAl | 0.4 | 20.5 | 0.75 | 23.1 | 1.35 |

Coercivity: kOe. Magnetization (residual flux density): T.

Each mixed powder was filled in a cemented carbide die having a cavity of φ10 mm and height 17 mm and was sealed at the top and bottom by cemented carbide punches.

This die/punch assembly was set inside a vacuum chamber, then the powder was reduced in pressure to 10⁻² Pa, was heated by a high frequency coil, and was press worked at 100 MPa immediately after reaching 600° C. It was held for 30 seconds after press working, then the bulk was taken out from the die/punch assembly. The height of this bulk was 10 mm (diameter φ10 mm).

Next, this was loaded into a separate φ20 mm cemented carbide die, the die/punch assembly was set in the chamber, then the bulk was reduced in pressure to 10⁻² Pa, was heated by a high frequency coil, and was hot swaged immediately after reaching 720° C. by a working rate of 60%.

After hot working, a sample including Cu as the added component was heat treated at 580° C. for 10 minutes to relieve the strain and a sample including Al as the added component was heat treated at 650° C.

After formation of the bulk and after hot working, the samples were measured for coercivity and magnetization (residual flux density). The results are shown together in Table 1.

In each case, due to the hot working, the magnetization of course and also the coercivity were greatly improved compared with a bulk. For improvement of the coercivity, the effect of the magnetic splitting of the main phase (Nd₂Fe₁₄B) due to the solidified layer of the added component liquid phase at the grain boundaries and slip planes is believed to effectively act.

<Effects of Particle Size of Added Component>

For the added alloy NdCu, the average particle size was changed to 30, 50, 80, 1000, and 3000 μm to investigate the effects on the coercivity. The results are shown in FIG. 4. From these results, it is learned that the average particle size of the added alloy powder has to be made 80 μm or more. If the alloy with the rare earth element such as NdCu is too fine, even if comminuting it in an inert atmosphere, it is believed that it ends up bonding with the slight amount of oxygen in the gas and oxidizing. On the other hand, Cu and Al has to be made as fine as possible, preferably several μm to several tens of μm (for example, about 37 μm) so as to facilitate alloying with the grain boundary phases.

<Effect of Hot Working Temperature>

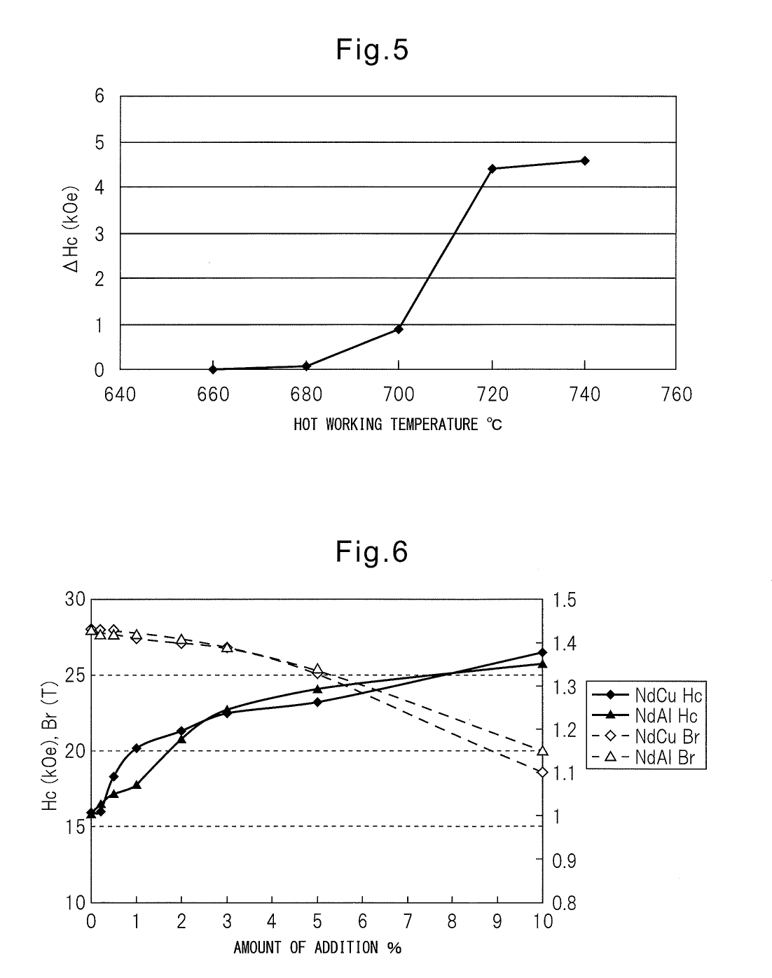

The effects of the hot working temperature on the coercivity after hot working when using an added alloy NdMn were investigated. The results are shown in Table 2 and FIG. 5.

TABLE 2

| Hot working temperature (° C.) | Hc (kOe) | ΔHc (kOe) |
|---|---|---|
| 660 | 15.8 | 0 |
| 680 | 15.9 | 0.1 |
| 700 | 16.7 | 0.9 |
| 720 | 20.2 | 4.4 |
| 740 | 20.4 | 4.6 |

FIG. 5 shows the amount of increase AH of the coercivity after hot working with respect to a coercivity 15.8 kOe of the bulk.

NdMn (Nd-15 wt % Mn) is a eutectic alloy. The melting point is 700° C. As shown in the results, the ΔHc rapidly becomes larger near the melting point of the NdMn. This is believed to be because by melting of the NdMn, the crystal grain boundaries and slip planes are coated and the effect of magnetic splitting in units of crystal grains and units of slip regions becomes remarkable.

<Effect of Type of Added Components>

In addition to the added components Cu and NdCu shown in Table 1, Nd and Nd+Cu were used to investigate the effects of the type of the added components on the coercivity. The results are shown in Table 3.

TABLE 3

| Added component | Hc | ΔHc | (Reference: |
|---|---|---|---|
| (type) | (kOe) | (kOe) | melting point ° C.) |
| Cu | 18.2 | 2.2 | 1083 |
| Nd | 16.4 | 0.4 | 1021 |
| NdCu | 22.5 | 6.5 | 520 |
| Nd + Cu(*) | 16.6 | 0.6 | — |

(*)Amount of addition: pure Nd2.55 wt % + pureCu0.45 wt % (total 3 wt %).

When adding Cu alone, the improvement in coercivity ΔHc over the case of no addition (case of “none” in column of “Added component” of Table 1) is 2.2 kOe. This is smaller compared with the ΔHc6.5 in the case of addition of NdCu (same for case of Al alone with respect to NdAl of Table 1). On the other hand, when adding Nd alone (3 wt %), ΔHc is a further smaller 0.4. The effect of addition is extremely limited. Furthermore, when just mixing Nd powder and Cu powder by amounts of addition the same as the NdCu alloy (total 3 wt %), the ΔHc was similarly a slow 0.6.

The types of the added components will be considered below.

<<Cu alone: AHc=2.2 kOe>>

The added Cu reacts with the Nd of the magnet alloy at the grain boundaries of the magnetic powder where the Nd-rich components are polycrystals whereby part forms a low melting point NdCu alloy and enables formation of a liquid phase. At the location of the grain boundaries where the NdCu alloy is formed, the concentration of Nd falls by that amount. Also, melting occurs due to the lower melting point. Therefore, the strain near the grain boundaries is relieved and the magnetic properties of the main phase can be exhibited more easily. However, the absolute amount of the Nd component present at the grain boundaries is smaller than the amount of Cu which is added, so ΔHc is this extent.

<<Nd alone: ΔHc=0.4 kOe>>

The melting point of Nd is 1021° C. or far higher than the hot working temperature. Further, the elements which can alloy with the added Nd to form a low melting point phase are also limited (here, the Co and Fe of the grain boundary parts correspond to this), so the effect of Nd alone is extremely limited.

<<NdCu alloy: AHc=6.5 kOe>>

An Nd-15 wt % Cu alloy is a eutectic alloy, has a melting point of 520° C., and becomes a liquid phase as whole at the hot working temperature 720° C. or less. The formed liquid phase sufficiently wets the crystal grain boundaries and slip planes at the time of hot working whereby the effect of magnetic splitting becomes remarkable and a large advantageous effect is obtained.

<<Nd+Cu: ΔHc=0.6 kOe>>

For the same reasons as with Cu alone and with Nd alone, the effect is extremely limited. Even if adding the same amount as the NdCu alloy, there is almost no meaning.

### Example 2

In this example, the effects of the amounts of addition of the added components were investigated.

The rare earth magnet materials were blended in predetermined amounts in accordance with an alloy composition (mass %): 31Nd-3Co-1B-0.4Ga-bal.Fe, the mixture was melted in an Ar atmosphere, and the melt was ejected from an orifice to a rotary roll (chrome-plated copper roll) for rapid cooling so as to produce a thin piece of alloy. This thin piece of alloy was comminuted in an Ar atmosphere by a cutter mill and sieved to obtain a rare earth alloy powder of a particle size of 2 mm or less (average particle size 100 μm). The crystal grain size of the powder particles was about 100 nm and the amount of oxygen was 800 ppm.

To the rare earth alloy powder, Nd-15 wt % Cu powder or Nd-96 wt % Al powder of an average particle size of 80 μm was added in amounts of addition of 0 to 10 wt % to prepare mixed powders. Specifically, the amounts of addition were 0.2, 0.3, 0.5, 1, 2, 3, 5, and 10 wt %.

Each mixed powder was filled in a cemented carbide die having a cavity of φ10 mm and height 17 mm and was sealed at the top and bottom by cemented carbide punches.

This die/punch assembly was set inside a vacuum chamber, was reduced in pressure to 10⁻² Pa, was heated by a high frequency coil, and was press worked at 100 MPa immediately after reaching 600° C. It was held for 30 seconds after press working, then the bulk was taken out from the die/punch assembly. The height of this bulk was 10 mm (diameter φ10 mm).

Next, this was loaded into a separate φ20 mm cemented carbide die, the die/punch assembly was set in the chamber, then the bulk was reduced in pressure to 10⁻² Pa, was heated by a high frequency coil, and was hot swaged immediately after reaching 680° C. by a working rate of 60%.

After hot working, a sample including Cu as the added component was heat treated at 580° C. for 10 minutes to relieve the strain and a sample including Al as the added component was heat treated at 650° C.

The obtained samples were measured for coercivity and magnetization (residual flux density). The results are shown in FIG. 6.

Regarding the coercivity Hc, with an amount of addition of 0.2 wt %, almost no effect could be recognized, while with an amount of addition of 0.3 wt % or more, a clear effect could be recognized. With an amount of addition of 0.5 wt % or more, a further clearer effect could be recognized. Hc gradually increases along with the increase in the amount of addition. Up to an amount of addition of 5 wt %, a remarkable effect of addition is recognized.

On the other hand, the magnetization (residual flux density) Br falls steadily along with an increase of the amount of addition. When the amount of addition becomes 10 wt %, the drop becomes remarkable.

This is because for improving the coercivity by magnetic splitting, the greater the amount of addition, the better, but if the amount of addition is too great, the main phase rate of the magnet falls and the magnetization falls.

Therefore, the amount of addition is preferably 0.3 wt % to 5 wt %.

### Example 3

In this example, an example of addition by coating the added component over powder particles of the rare earth magnet alloy will be explained.

The rare earth magnet materials were blended in predetermined amounts in accordance with an alloy composition (mass %): 31Nd-3Co-1B-0.4Ga-bal.Fe, the mixture was melted in an Ar atmosphere, and the melt was ejected from an orifice to a rotary roll (chrome-plated copper roll) for rapid cooling so as to produce a thin piece of alloy. This thin piece of alloy was comminuted in an Ar atmosphere by a cutter mill and sieved to obtain a rare earth alloy powder of a particle size of 2 mm or less (average particle size 100 μm). The crystal grain size of the powder particles was about 100 nm and the amount of oxygen was 800 ppm.

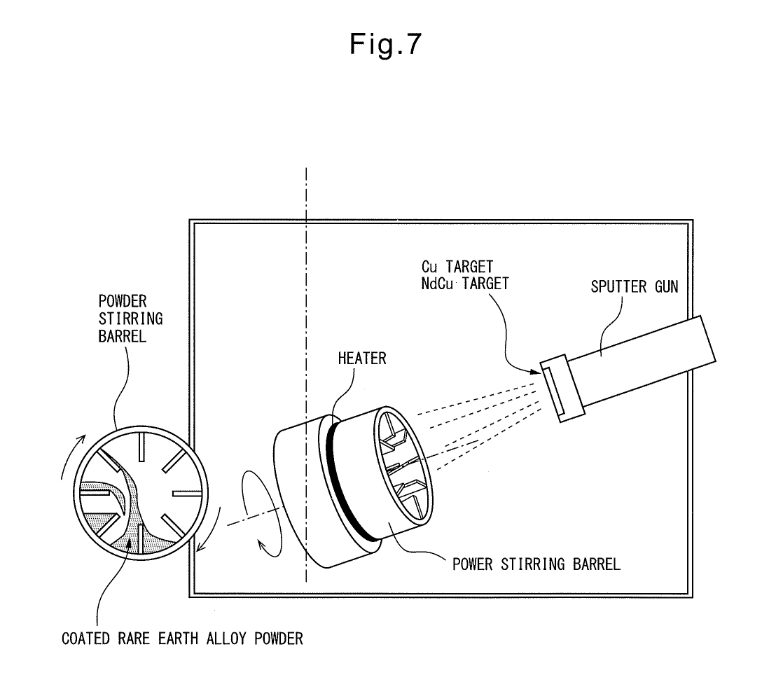

To the above rare earth alloy powder, pure Cu or Nd-15 wt % Cu alloy was sputtered as a target aiming at an average film thickness of 0.5 μm. FIG. 7 shows a schematic view of the apparatus used.

The coated rare earth alloy powder obtained by coating the added component on the surface of the particles by sputtering was filled in a cemented carbide die having a cavity of φ10 mm and height 17 mm and was sealed at the top and bottom by cemented carbide punches.

This die/punch assembly was set inside a vacuum chamber, was reduced in pressure to 10⁻² Pa, was heated by a high frequency coil, and was press worked at 100 MPa immediately after reaching 600° C. It was held for 30 seconds after press working, then the bulk was taken out from the die/punch assembly. The height of this bulk was 10 mm (diameter φ10 mm).

Next, this was loaded into a separate φ20 mm cemented carbide die, the die/punch assembly was set in the chamber, then the bulk was reduced in pressure to 10⁻² Pa, was heated by a high frequency coil, and was hot swaged immediately after reaching 680° C. by a working rate of 60%.

After hot working, the samples was heat treated at 580° C. for 10 minutes to relieve strain.

The obtained rare earth magnet samples were measured for coercivity and magnetization (residual flux density). The results are shown in Table 4.

TABLE 4

| | Amount | Bulk | | After hot working | |
|---|---|---|---|---|---|
| Added | of addition | | Magneti- | | Magneti- |
| component | (wt %) | Coercivity | zation | Coercivity | zation |
| None | — | 17.0 | 0.80 | 16.0 | 1.43 |
| Cu | 2.5 | 17.0 | 0.78 | 18.3 | 1.42 |
| NdCu | 2.5 | 18.3 | 0.77 | 23.0 | 1.40 |

Coercivity: kOe. Magnetization (residual flux density): T.

Even when either adding Cu alone or adding an NdCu alloy, substantially equivalent effects are obtained as with mixing in the powder state in Example 1. However, while not appearing in the results, compared with mixing in the powder state, addition in a state coated over powder particles enables uniform addition, so it is believed possible to keep the fluctuation in quality down. On the other hand, sputtering is performed in vacuum in batch treatment, so mixing as powder is probably more advantageous in terms of productivity and cost.

### INDUSTRIAL APPLICABILITY

According to the present invention, a method of production of a rare earth magnet which achieves high magnetization by hot working and at the same time secures high coercivity is provided.

1-4. (canceled)

5. A method of production of an R-T-B-based rare earth magnet comprising:
molding a powder of an R-T-B-based rare earth alloy (R: rare earth element, T: Fe or Fe part of which is substituted by Co) into a bulk,
then hot working the bulk, and
before the molding, mixing with the powder of an R-T-B-based rare earth alloy an alloy which forms a liquid phase at a temperature lower than the hot working temperature as a powder of a powder particle size of 80 μm or more.

6. The method as set forth in claim 5, wherein the alloy which forms a liquid phase at a temperature lower than the hot working temperature is an alloy with a rare earth metal.

7. The method as set forth in claim 6, wherein the alloy with a rare earth metal is one of NdCu, NdAl, NdMn, PrCu, DyCu, DyAl, and DyCuAl.

8. The method as set forth in claim 5, wherein the R-T-B-based rare earth alloy is Nd₂Fe₁₄B.

9. The method as set forth in claim 6, wherein the R-T-B-based rare earth alloy is Nd₂Fe₁₄B.

10. The method as set forth in claim 7, wherein the R-T-B-based rare earth alloy is Nd₂Fe₁₄B.
